(19) United States
(12) Patent Application Publication
(10) Pub. No.: US 2026/0233828 A1
(43) Pub. Date: Aug. 13, 2026

(54) DUCTED FAN AIR VEHICLE

(71) Applicants: Philip Kelly, Ottawa (CA); Venture Kel Inc., Ottawa (CA)

(72) Inventors: Philip Kelly, Ottawa (CA); Gemma Venturino, Ottawa (CA)

(21) Appl. No.: 19/533,506

(22) Filed: Feb. 9, 2026

Related U.S. Application Data
(60) Provisional application No. 63/755,519, filed on Feb. 7, 2025.

(51) Int. Cl. B64C 15/02; B64C 21/10; B64C 27/20; B64C 29/00; B64D 29/06; B64D 33/04

(52) U.S. Cl. CPC B64C 15/02; B64C 21/10; B64C 27/20; B64C 29/0016; B64D 29/06; B64D 33/04

(57) ABSTRACT

A ducted fan(s) is embedded in a duct in a vehicle (such as an air vehicle) with a shaped and enhanced aerodynamic intake(s) interacting with a primary purpose of lift inducement, with the exhaust(s) primary purpose as a lift system with containment to optimize lift and deflection at the outlet for the secondary purpose of control.

### TECHNICAL FIELD

This document relates to the technical field of (and is not limited to) (A) a ducted fan for an air vehicle, (B) a ducted fan air vehicle, (C) heavy lift ducted fan air vehicle duct aerodynamics, (D) an aerodynamic enhancement for a ducted fan usable on an air vehicle, and/or (E) a method of any thereof.

### BACKGROUND

It is known for providing an open-rotor quadcopter drone with heavy-lift capacity.

U.S. Pat. No. 11,117,658 discloses a Propulsion system for an aerial vehicle.

U.S. Pat. No. 3,388,878 A discloses a VTOL (Vertical Take-Off-and Landing) aircraft with balanced power and a retractable lift fan system.

United States Patent Number US 2022/0041264 A1 discloses an aircraft that includes wings with integrated ducted fans.

United States Patent Number US 2021/0237852 A1 discloses that an aircraft has a ducted fan having a duct with an electrical machine integrated into it.

U.S. Pat. No. 11,097,838 B2 discloses a duct with an optimized horizontal stator shape.

U.S. Pat. No. 11,091,258 B2 discloses a VTOL aircraft with tilting rotors and tilting ducted fans.

United States Patent Number US 2017/0159674 A1 discloses that an aircraft has a ducted fan having a duct with a variable-area nozzle, including an exhaust of the variable-geometry ducted fan having a variable exhaust area.

### SUMMARY

It will be appreciated that there exists a need to mitigate (at least in part) at least one problem associated with known open rotor vertical take off and landing air vehicles, the optimization of rotor use in ducts, and/or optimization of interaction of airflow with aircraft body and/or control vanes, etc. (also called the existing technology). After much studying and experimenting with the known devices, an understanding (at least in part) of the problem and its solution has been identified (at least in part) and articulated (at least in part) as follows:

To mitigate the known technology, there is provided (A) heavy-lift ducted-fan drone aerodynamics at the inlet and exhaust, and/or (B) a ducted-fan air vehicle conceptual design in which ducted fans interact to mitigate known problems and/or for benefit.

A major aspect can provide a system for lift optimization for a vehicle, such as, but not limited to, an air vehicle, a drone, or a subsea vehicle. More specifically, the major aspect provides aerodynamic lift, inducing shaping around ducted fan(s) embedded or positioned to provide lift to an air vehicle. The duct, in cross-section, is internally shaped like the top of a wing profile, set on its end and circular around a ducted fan. An impeller is placed in the resultant duct to accelerate air and achieve maximum lift from direct thrust, with aerodynamic shaping providing additional lift. Aerodynamic shaping includes adding slats or a circular or radial stator stage at the entry to the duct to provide lifting vectors, and strakes adjacent to the exhaust duct(s) exits to contain high-pressure air when multiple ducts exhaust, forming a central rising column of air below a vehicle. These aerodynamic features improve overall vehicle lift performance and provide the conceptual basis for ducted fans to interact in a mutually beneficial manner.

At least one duct includes a high-mass-flow and low-pressure-inducing shape at an intake, which can provide compound aerodynamic benefits across multiple ducts configured to create a low-pressure area above a vehicle. The intake may be bifurcated, with two or more inlets. These inlets contribute to aerodynamic effects, such as maintaining airflow boundary-layer attachment on the top of lifting surfaces to improve lifting performance by generating low-pressure areas.

A separate intake, movable cowl can reduce intake size for forward flight to minimize drag and improve intake dynamics. It is retracted for hover evolutions and deployed forward for fixed-wing flight. It can be linearly or radially actuated into position. It allows maximum mass flow in a hover by not constricting the intake, and it enables higher air vehicle velocity by not inducing additional intake drag. It bends the air into the face of the ducted fan in transition and in fixed-wing flight. In a decelerating transition, it retracts and, if required, can act as an airbrake to reduce transition length in distance and time.

At least one duct is provided with thrust, adding airflow from an impeller device that induces a low-pressure area at the inlet through aerodynamic force. The thrust addition to the airflow comes from an impeller, such as a fan or an airflow-inducing mechanism embedded in the duct, with blades optimized for still-air lift. The impeller in the duct may be rim driven to increase efficiency for a given duct cross-sectional area. Impeller blades may be spaced to avoid harmonics and shaped to spread noise frequencies.

The exhaust duct may be shaped to optimize mass flow and enhance thrust efficiency, thereby reducing drag and energy consumption. Shaping for impeller cooling, noise reduction and improved stability and control are also included. The duct(s) exhaust outlet(s) may be configured with additional structure(s), such as strakes, to contain a high-pressure region maintained between them by the recirculating rising central air column in ground effect. These strakes may be aligned with freestream air in forward flight, and cross-flight-path strakes to contain high-pressure air fore and aft may be retractable. These may have a secondary purpose of thrust deflection as outlined below. A smaller lip on the forward edge of the duct(s) exhaust outlet in forward flight may be added to increase lift in forward flight.

The exhaust may benefit from thrust deflection at the outlet for at least one secondary purpose, such as manoeuvre in the hover or cruise, and/or alignment to reduce pitching moments if mounted off the vehicle thrust line. Exhaust may also be vectored to an optimum angle based on the vehicle installation. A bifurcated exhaust duct may also be used to maintain thrust addition symmetry during vehicle operation. Vanes placed in the exhaust or at the edge of the exhaust may be considered powered control surfaces for station keeping and maneuvering of the air vehicle.

A variable-area/shape outlet may provide additional flow area for the discharge of a higher volume of accelerated air in hover or allow more efficient cruise flight by reducing the exhaust area through deflection of the control vanes. A separate feature may be the addition of an exhaust leading-edge fillet.

The major aspect may possess at least one or more benefits and/or advantages over known ducted fan(s) methods and systems. In particular, the major aspect utilizes reliable lift-inducing aerodynamic structures and low-pressure-inducing principles at the duct(s) intakes, and high-pressure containment at the duct(s) exhausts, thereby affording component placement flexibility and user cost reductions due to more efficient flight conditions.

Moreover, the aerodynamically enhanced ducted fan(s) may not require hole blanking due to the aerodynamic structures (slats) at the intake, which provide a safety barrier to the duct(s) entry for large foreign objects and thereby diminish the risk of impeller failure from such ingestion. Maintenance labour requirements and their associated costs are reduced by the efficiencies gained from the aerodynamic features at the duct(s) inlet and exhaust described here. Because of its flexibility, ease of use, and installation, the ducted fan(s) of the major aspect may realize a reduction in manufacturing and ongoing maintenance costs compared to open-rotor designs with exposed blades and attendant safety risks.

A practical example of the major aspect's flexibility is its ability to be mounted on or installed in a vehicle, such as an air vehicle. For instance, user specifications may require that thrust be positioned in specific locations within a vehicle, such as an aircraft fuselage or air-vehicle structure, to accommodate other vehicle features, such as a passenger or payload compartment or an attachment point for load lifting. The ducted fan(s) of the major aspect, given its separable principle as thrust provision of a vehicle, such as an aircraft or an air vehicle, is preferably suited for the preceding application, as well as other applications wherein flexibility, safety and economy may be desired.

In addition to the foregoing attributes, the ducted fan(s) system may offer other electrical and mechanical benefits over conventional devices. Electrical features of the embedded impeller or fan (centrally driven or rim driven) may include improved revolutions per minute (RPM) rise times and/or lower drive draw as opposed to those for typical compliant thrust, such as an open rotor system or a direct gas turbine vectored thrust system capable of higher thrust regimes. Furthermore, infrared (IR) radiation from compliant main engines with hot-gas exhaust may be reduced or, preferably, eliminated, a major aspect in military applications.

An energy storage and charging system is to be associated with the duct(s) and impeller(s) and may be electrically charged or use another form of energy storage, such as fuel or hydrogen. Storage options include batteries and/or tanks to hold fuel or hydrogen, which may be incorporated into a structure. The powertrain could also include microturbines or fuel cells, providing a choice of how to allocate the useful load between Sustainable Aviation Fuel or Hydrogen and payload. A flight control system is required for embodiments that incorporate it into vehicles. This will drive the vanes placed in the exhaust as powered control surfaces.

The weight of the ducted fan(s) system and aerodynamic structure may be more than offset by the fuel saving achieved by not using an open rotor system. Open-rotor fuel burn rates may be higher than those of ducted fan(s) for typical equivalent applications. Moreover, no risk of tail rotor failure or cascading blade failure across separate rotors exists if using the ducted fan(s) system with inherent structural impeller failure containment rings like those seen in jet engines. Access protection for the impeller in the form of an intake stator stage (radial or circular) can be established, as well as protection of the exhaust access using the exhaust guide vanes. The size of the foreign object protected against may vary depending on the particular embodiment.

For landing throttle modulation, using an impeller within the aerodynamically enhanced duct(s) will keep noise to a minimum and provide steady-state power. Noise primarily comes from the rotor, so maintaining steady power settings in ducted fan(s) by modulating an exhaust thrust deflection system, such as strakes, would be particularly useful for reducing noise. Exhaust thrust deflection would be the primary positional flight control in this case.

An embodiment creates a high-pressure area under an air vehicle to induce lift and benefit from thrust containment from the air exiting from duct(s) outlet(s). The recirculated thrust containment system comprises strakes aligned with flight direction and vanes used for lateral positional control across the air vehicle. Using this embodiment reduces the size of the optional wings added to produce lift at slow speeds. The embodiment may provide a benefit when in ground effect. There would be the added benefit of reduced wing-induced lift-dependent drag during acceleration or at low speeds. The weight of the embodiment will be less than the weight of the wing designs in current use.

A secondary benefit of ducted fan(s) with electric or other impellers within the duct is that they gain the efficiency of duct mounting. Because an air vehicle has limited fuel or energy due to its high fuel or energy burn rate, the ducted fan(s) system weight is likely to be less than the additional fuel and associated system weight required. Due to the reduced weight of fuel or energy, it would not necessarily impact mission success as a proportion of useful load in such a critical manner.

Similarly, the mechanical features of the electrical impeller or fan with motor enable it to tolerate more use cycles than conventional engine devices and, as previously discussed, liberate it from the specialized installation and maintenance protocols required for traditional provision of lift that significantly affect the vehicle's (such as an aircraft's) designed outer mold line. An example of this is a helicopter fuselage impinging on the rotor downwash, resulting in an estimated 15% thrust loss and requiring shaping to accommodate it. A series of ducted fans with impellers limited only by bearing life is a more straightforward maintenance task than a complex epicyclic gearbox to reduce rpm for a single large main helicopter rotor. The mould line of a vehicle with ducted fans can optimize the generation of low-pressure areas on its upper surfaces throughout all phases of flight. In hover mode, it is the interaction of multiple ducted fans that generates a compound benefit. In fixed-wing flight, it is the effect of sucking the boundary layer, similar to known blown boundary-layer systems.

An aspect pertains to a fan embedded in a duct open to the free-stream air, mounted in a vehicle (such as an air vehicle). The duct includes a low-pressure-inducing profile at the intake, with additional aerodynamic devices in the form of slats. Multiple duct(s) intakes interact to create more lift through the compound benefits of a more effective lift, inducing a low-pressure area on the top of a vehicle. The thrust added to the airflow is generated by an impeller, such as a fan or an airflow-inducing mechanism embedded or positioned in the duct. The ducts are designed to accommodate a corresponding impeller, such as a fan or an airflow-inducing mechanism, so that the impeller generates aerodynamic force, providing thrust to the air vehicle through the duct's exhaust accelerated air. An intake cowl can deploy to reduce the intake size in fixed-wing flight to allow a higher speed to be attained. The duct exhaust and related containment strakes are shaped to induce a high-pressure area beneath the air vehicle and to enable thrust deflection. The aerodynamically enhanced ducted fan(s) are designed to be separably mounted on (or in) a vehicle, such as an air vehicle. The ducts are adapted to be associated with through runs and/or airflow-inducing systems.

In accordance with a first major aspect, there is provided an apparatus comprising: a vehicle; and an aerodynamically enhanced ducted fan system configured to be mounted to the vehicle and to urge movement of the vehicle.

In accordance with a second major aspect, there is provided a method of moving a vehicle including a ducted fan system, the method comprising: activating the ducted fan system with aerodynamic enhancements and shaping configured at an inlet and an exhaust to urge movement of the vehicle.

In accordance with a third major aspect, there is provided a method of vehicle control comprising: activating the ducted fan system configured to vary or deflect the duct outlet air.

In accordance with a fourth major aspect, there is provided a method of vehicle noise signature management including a ducted fan system, the method comprising: activating the ducted fan system, which is configured to spread frequencies and absorb noise.

In accordance with a fifth major aspect, there is provided a method of thrust deflection in hover flight, the method comprising: activating the ducted fan thrust deflection system configured to create lateral force to induce lateral movement, thereby providing a benefit without reducing overall air vehicle lift.

In accordance with a sixth major aspect, there is provided a method of thrust deflection in transition and fixed wing flight, the method comprising: activating the ducted fan thrust deflection system configured to create powered control forces to provide flight control in transition and fixed wing flight, whereby the method provides benefit in not causing additional aerodynamic drag from conventional airframe mounted control surface deflection.

In accordance with a seventh major aspect, there is provided a heavy-lift ducted fan vehicle system comprising: at least one ducted fan embedded within a vehicle structure, the ducted fan including a duct housing and an internal impeller; an aerodynamic intake comprising a plurality of intake slats and a movable intake cowl, and said movable intake cowl configured to retract during a hover phase to maximize mass flow and to deploy forward during a fixed-wing flight phase to reduce intake area and drag; and an exhaust system comprising a plurality of vertical exhaust strakes, control vanes, and at least one forward exhaust lip, wherein the strakes and vanes are configured to contain a high-pressure air region beneath the vehicle when in ground effect.

In accordance with an eighth major aspect, there is provided a method of inducing lift and providing control for a ducted fan vehicle, the method comprising: activating a ducted fan system embedded in a vehicle airframe; manipulating an intake cowl between a retracted hover position and a deployed forward-flight position to optimize airflow velocity and drag; capturing a recirculating thrust bubble between a plurality of exhaust strakes to provide ground-effect lift; and deflecting air at a duct outlet via a plurality of vanes to induce lateral movement without reducing overall vehicle lift.

In accordance with a ninth major aspect, there is provided a method of increasing the efficiency of a VTOL vehicle, the method comprising: utilizing a duct cross-section shaped as a circularized wing profile to generate low pressure on the vehicle's upper surface; employing a forward exhaust lip on a leading edge of a duct outlet to increase the maximum coefficient of lift during forward flight; and maintaining a steady-state power setting during hover by utilizing vertical strakes to trap high-pressure air beneath the vehicle and vanes to provide control.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in a simplified form, which are further described in the Detailed Description below. This Summary is not intended to identify potentially key features or possible essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a cross-sectional view of an embodiment of an aerodynamic shaping and enhancement of a configuration of a ducted fan for an air vehicle, which is generally depicted in FIG. 3, in which the ducted fan can be utilized as a primary thrust provider in the air vehicle, such as a vertical heavy lift air vehicle.

FIG. 2 depicts a plan view of an embodiment of at least one air vehicle ducted fan surrounding a lift, inducing a low-pressure area

FIG. 3 depicts a cross-sectional view, through a cross-sectional line A-A, of an embodiment of the at least one air vehicle ducted fan of FIG. 2, showing a high-pressure containment underneath for the air vehicle.

FIG. 4 depicts a cross-sectional view of an alternative embodiment of the at least one air vehicle ducted fan of FIG. 2, including exhaust leading edge vanes

FIG. 5 depicts a side lateral perspective view of an air vehicle.

FIG. 6 depicts a top rear perspective view of the air vehicle of FIG. 5.

FIG. 7 depicts a cross-sectional side view of the air vehicle of FIG. 5.

FIG. 8 depicts a front view of the air vehicle of FIG. 5.

FIG. 9 depicts another front view of the air vehicle of FIG. 5, including airflow.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some elements in the figures may be emphasized relative to other elements to facilitate understanding of the various disclosed embodiments. In addition, common and well-understood elements that are useful in commercially feasible embodiments are often not depicted to provide a less obstructed view of the embodiments of the present disclosure.

### LISTING OF REFERENCE NUMERALS USED IN THE DRAWINGS

100 Air vehicle
101 Intake devices
102 Duct
103 Impeller (optionally rim driven)
104 Stator stage
105 Exhaust outlet front lip and/or vane
106 Strake
201 Multi-duct, optionally rim-driven, impeller array (also called fans)
202 Integrated low-pressure upper surface
203 Modular stub wing assembly
204 High-pressure containment strakes
205 Lower lip extension/forward exhaust lip
207 Recirculating airflow path
206 Intake aerodynamic devices (also called intake slats)
207 Recirculating airflow path
502 Movable intake cowl
504 Ducted fan intake
702 Thrust vector vanes
804 Recirculating thrust bubble strakes

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure. They are not intended to limit the scope of the disclosure. The claims define the scope of the disclosure. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the disclosure is limited to the subject matter provided by the claims, and that the disclosure is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

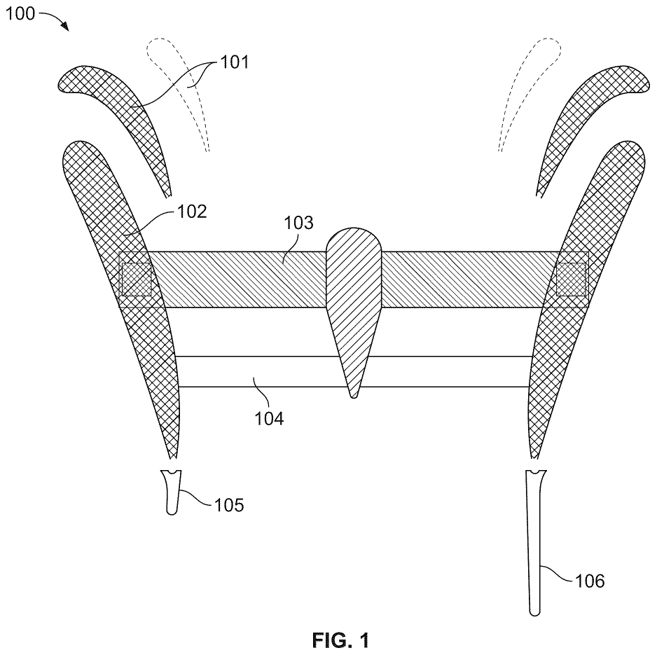

Referring to FIG. 1, there is depicted a cross-sectional view of an aerodynamically enhanced ducted fan assembly configured for a vertical take-off and landing (VTOL) vehicle. This embodiment provides a modular lift system that combines direct thrust with advanced aerodynamic shaping to optimize lift-to-power ratios.

Referring to FIG. 1, there is depicted an airflow intake devices 101 (also called aerodynamic slat/stator stage) that define an intake geometry configured to facilitate high mass flow while minimizing turbulence. An engineering advantage of this specific curvature is that it accelerates incoming air, creating a low-pressure area on the vehicle's upper surface, which contributes to passive aerodynamic lift even before the impeller increases thrust. Secondarily, it provides a physical safety barrier at the duct entry to prevent the impeller from ingesting large foreign objects. Referring to FIG. 1, an aerodynamic duct 102 is depicted and is configured to provide maximum thrust. Primarily, it acts as a wing to maintain airflow boundary-layer attachment along the duct, preventing separation that would otherwise cause drag or lift loss. Secondarily, it provides a physical barrier to prevent a blade from being shed into the duct and protects the air vehicle and the surrounding environment.

Referring to FIG. 1, an impeller 103 is depicted. It will be appreciated that the impeller can be rim-driven optionally. In the position (as shown), it allows maximum unconstricted mass flow for heavy-lift hover operations. When used during forward high-speed fixed-wing flight, it benefits from a reduced overall intake aperture provided by a deployable (movable) cowl, significantly decreasing parasitic drag and bending the air more efficiently into the impeller's face to optimize intake dynamics. An engineering benefit is a reduction in drive draw and improved rise times for RPM (Rotations Per Minute). Additionally, the blades are specifically spaced and shaped to spread noise frequencies across a broader spectrum, thereby managing the vehicle's acoustic signature and reducing overall noise pollution.

Referring to FIG. 1, a stator assembly 104 (also called a stator stage) is depicted to maximize efficiency for the given duct cross-sectional area by correcting any torsional flow. An engineering benefit is a reduction in drive draw and improved rise times for RPM (Rotations Per Minute).

Referring to FIG. 1, there is depicted an exhaust outlet front lip/vane 105. This geometry is configured to reduce drag on the duct exhaust in forward flight.

Referring to FIG. 1, an exhaust outlet strake 106 is depicted, defining an exhaust path shaped to optimize mass flow and enhance thrust efficiency. The vanes at the outlet are not merely structural; they are powered control surfaces that can deflect air to provide flight control forces (lateral movement, station keeping, or pitching moment correction) without the drag penalty associated with traditional external control surfaces like ailerons or rudders.

### Cooling System

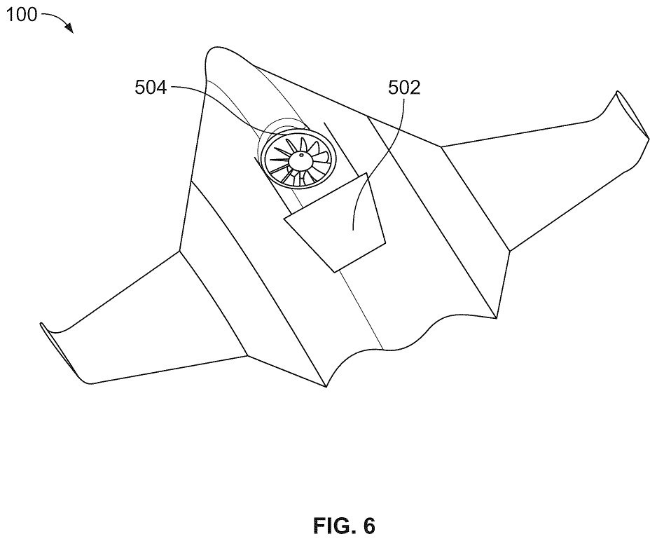

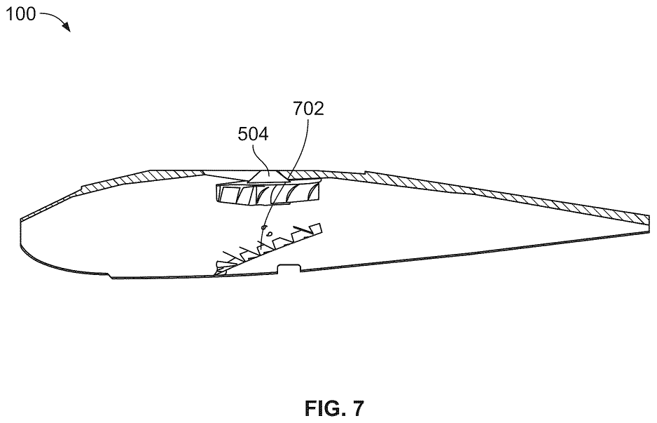

Referring to FIG. 1, the air vehicle can incorporate a thermal management system configured to dissipate excess heat generated by the propulsion motors and power electronics during various high-load operations, such as vertical hover mode. In one embodiment, as exemplified in the configurations of FIG. 6 and FIG. 7, the system utilizes the high-mass-flow environment within the ducted fan assembly to provide direct air cooling to the internal components. Additionally, the duct 102 and stator stage 104 are configured to support integrated heat-exchange interfaces, which can include air-cooled heat sinks or conduits for a closed-loop liquid-cooling system, so that the thermal energy is transferred into the bypass airflow to maintain optimal operating temperatures, preferably without significantly increasing aerodynamic drag.

### Vibration Management

Referring to FIG. 1, it will be appreciated that vibration management is a critical factor in maintaining the vehicle's structural integrity and operational reliability. Precise balancing of the impeller 103 can be required to minimize harmonic oscillations within the duct housing 102. To protect sensitive flight systems, the avionics suite is installed using anti-vibration mounts, also called dampeners, at its attachment points to the primary vehicle structure, effectively isolating the control electronics from high-frequency mechanical noise generated by the propulsion units. This management strategy ensures the accuracy of flight control sensors and extends the fatigue life of the airframe components.

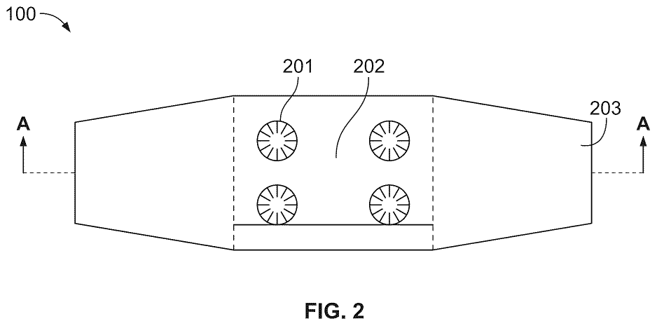

Referring to FIG. 2, a top-down plan view of a heavy-lift air vehicle embodiment is depicted, illustrating the strategic integration of a plurality of aerodynamically enhanced ducted fans within a unified airframe to achieve compound lifting benefits.

Referring to FIG. 2, a multi-duct rim-driven impeller array 201 (also called the fans) is depicted; this embodiment utilizes a quad-cluster of four rim-driven ducted fans embedded directly into the primary structural core of the vehicle. By using a four-point “rim-driven” configuration rather than a central-hub motor, the design eliminates the heavy epicyclic gearboxes typically required for high-torque lift rotors. This allows for a more compact vertical profile and provides “instantaneous RPM rise times,” which are critical for the rapid stabilization and attitude control of a heavy-lift platform. An advantage of this arrangement is that the distribution of four separate thrust centres provides inherent redundancy; the flight control system (FCS) can compensate for a partial loss of power in one duct by modulating the RPM of the opposing pair, ensuring safe “engine-out” landing capabilities. It will be appreciated that this arrangement can be a backup mode. The primary mode is vane-induced thrust vectoring under (relatively) constant rpm.

Referring to FIG. 2, an integrated low-pressure upper surface 202 is depicted. The top surface of the vehicle body between and around the duct intakes is engineered as a continuous aerodynamic lifting body. Placement of the ducts for the impeller array 201 is configured so that the high-velocity intake suction of each fan interacts with the others. This creates a compound aerodynamic benefit where a massive, stable zone of low pressure is maintained across the entire upper surface 202. An advantage is that, unlike traditional helicopters, where the fuselage is a source of drag (thrust loss), this configuration turns the vehicle's body into a lifting wing even during a vertical hover. This “passive lift” reduces the total power draw from batteries or fuel cells required to maintain a steady altitude.

Referring to FIG. 2, a modular stub wing assembly 203 is depicted, which is positioned at the lateral extremities of the airframe. The stub wings provide a secondary lift source and structural mounting points. The stub wings 203 are configured with a profile that complements the “circularized wing profile” of the main ducts. During the transition to forward flight, the lift burden shifts from the ducted fans to these surfaces. An advantage is that these wings reduce the wing-induced drag typically seen in slow-speed VTOL flight. Because the vehicle already generates significant lift from the body 202, these wings can be much smaller and lighter than those found on conventional tilt-rotor aircraft, reducing the overall vehicle weight and improving the useful payload fraction. An advantage of this arrangement is the reduction and/or prevention of aerodynamic stalling during the critical transition phase between hover and cruise. By maintaining boundary-layer attachment, the vehicle can transition at lower speeds and with greater stability than open-rotor designs, while the internal mounting of the fans (201, also called an impeller array) protects personnel and ground equipment from exposed rotating blades.

### Compound Interaction & Mold Line Optimization

Referring to FIG. 2, there is depicted an outer mold line of the vehicle, which can be optimized to act as a blown boundary-layer system. As the vehicle gains forward velocity, the air entering the leading-edge ducts is “sucked” across the upper surface, ensuring that the airflow remains “attached” even at high angles of attack.

### Electrical Demands

Referring to FIG. 2, the electrical demands of the impeller array 201 can be dynamically balanced against the available output of an onboard hydrogen fuel cell system (not shown and known) to meet the instantaneous thrust requirements of the air vehicle. This power-to-thrust ratio can be optimized by the vehicle's aerodynamic profile, which reduces the total electrical load required to overcome parasitic drag during forward flight and utilizes the integrated low-pressure upper surface 202 to augment lift, thereby extending the operational range provided by the hydrogen fuel source.

### Material Selection

Referring to FIG. 2, it will be appreciated that the material selection for the components of the air vehicle can be tailored to the operational scale and specific component requirements to optimize the strength-to-weight ratio. The duct housings 201 and fan blades can be constructed from lightweight composite materials. At small scales, the body of the air vehicle can be composite, aluminum alloy, or high-density body foam, depending on the air vehicle's size. Conversely, for heavy-lift or larger-scale air vehicles, these same components, along with the primary structural upper surface 202, may be fabricated from aerospace-grade aluminum or advanced carbon-fibre composites to withstand higher structural loads and thermal stresses while maintaining aerodynamic rigidity and minimizing aeroelasticity. Material selection can ensure that the structural integrity of the ducted fan system is maintained across various vehicle sizes, preferably without compromising the lift-to-power efficiency. Material selection will vary for extreme cold conditions, as seen in the Arctic. Additionally the duct housings can be considered to be torsion boxes from a structural rigidity point of view. This allows overall vehicle structural weight savings when they are placed between wing spars (if used).

### Power and Torque Requirements

Referring to FIG. 1 and FIG. 2, the impeller system 103 can be driven by an electric motor, preferably optimized for higher power capabilities and/or higher torque-to-weight ratios, to ensure the necessary responsiveness for (nearly) instantaneous changes to the rotational speed of the electrical motor during operations, such as heavy-lifting operations. The electrical motor can be configured to provide sufficient torque to maintain steady-state hover stability while minimizing the overall mass of the propulsion unit embedded within the duct 102. It will be appreciated that the electrical motor can be integrated into the duct rim (rim-driven) or centrally located, using motor configurations that prioritize high-frequency response and motor thermal management to reduce the drive's energy requirements during vertical take-off and transition, particularly with a higher vehicle payload. The same motor would benefit from achieving high efficiency at 20-30% rpm to maximize the endurance of the air vehicle in forward flight. The high power availability will allow the air vehicle to achieve a high top speed.

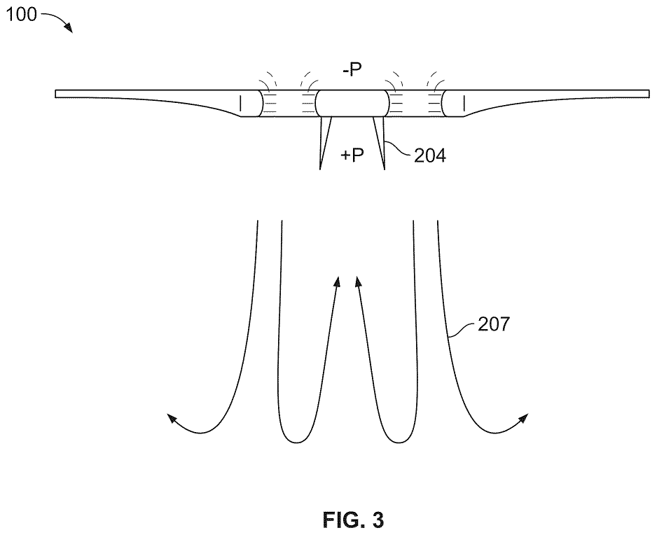

Referring to FIG. 3, an air vehicle in a hover configuration is depicted, specifically detailing the interaction between the exhaust flow and the landing surface to maximize operational efficiency in ground effect.

Referring to FIG. 3, high-pressure containment strakes 204 are depicted. These vertical structural elements are positioned at the duct outlets to manage the exhaust plume. Strake 204 is aligned with the vehicle's primary flight direction and serves as a fence to prevent the high-velocity exhaust from immediately dissipating laterally. By trapping the air, they create a pressurized region—labelled as (+P) in the diagram—directly beneath the vehicle's centre of gravity. An advantage is that this configuration captures a recirculating thrust bubble or a rising central air column. The primary engineering advantage is the ability to maintain steady-state hover at a significantly lower power setting (reduced throttle modulation) than open-rotor designs, which lose this energy to the surrounding environment.

Referring to FIG. 3, a recirculating airflow path 207 depicts the trajectory of the accelerated air after it exits the duct and interacts with the ground. As the exhaust air hits the surface, it naturally seeks to move outward. The strakes 204 contain a portion of this air that has recirculated upward toward the vehicle's underbelly, creating a fountain effect. An advantage is that this rising column of air provides a cushion of lift. This reduces the energy consumption and fuel burn rate, which is critical for extending the mission range of heavy-lift VTOL platforms.

### Control and Stability Through Thrust Containment

Referring to FIG. 3, the strakes 204 also serve a secondary purpose in directional stability. By containing the high-pressure air, they provide a stable “base” that minimizes the vehicle's tendency to drift or “skate” on its own exhaust during the critical moments of take-off and landing. An advantage is that this increased stability reduces the workload on the Flight Control System (FCS) and allows for precision station-keeping in challenging environments, such as landing on moving platforms or in confined urban spaces. It also serves a similar function to a rudder, maintaining directional stability in forward flight. Aerodynamic advantage is achieved by using the strakes 204 to manage airflow 207; the system creates a high-pressure zone (+P) that offsets a portion of the vehicle's weight. This allows the vehicle to carry a larger useful load or operate with a smaller wing than would otherwise be required for low-speed flight.

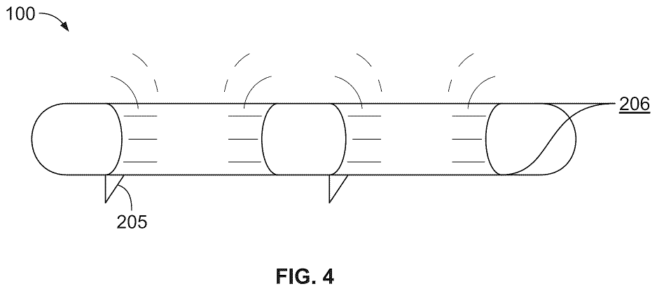

FIG. 4 provides a detailed side view of the ducted fan assembly, highlighting the specific aerodynamic components that allow the vehicle to maintain high lift and stability during forward flight transitions.

Referring to FIG. 4, a lower lip extension 205 (also called a leading-edge exhaust lip/vane) is depicted. This feature is a protrusion located at the forward-most edge of the exhaust outlet. In forward flight, the incoming air creates a high-velocity stream across the bottom of the duct(The lower lip extension 205 is shaped to act as a Gurney flap for the duct's leading edge, creating a localized high-pressure zone just before the exhaust air exits. This pressure differential increases the circulation around the duct profile, effectively increasing the maximum coefficient of lift (CLmax) by up to 50%. This, advantageously, allows the vehicle to generate significant aerodynamic lift from the duct housing itself during forward flight. This arrangement reduces, at least in part, the lift requirement from the impellers, allowing lower power settings and higher cruise speeds while preventing the “nose-down” pitching moments that are common to traditional ducted fan designs or configurations.

Referring to FIG. 4, intake slats 206 (also called intake aerodynamic devices) are depicted. These are secondary aerodynamic surfaces positioned at the duct intake. The slats 206 (also called intake aerodynamic devices) create multiple narrow intake paths. In high-speed forward flight or high angles of attack, these slats accelerate a small portion of air through the “slot” and inject it directly onto the upper surface of the duct. This high-energy air re-energizes the boundary layer, ensuring it remains “attached” to the surface rather than separating and creating turbulent drag.

Referring to FIG. 4, by maintaining boundary layer attachment, the slats 206 (also called intake aerodynamic devices) are configured to prevent aerodynamic stalling of the duct housing. This allows the vehicle to operate safely at much steeper angles of attack during the transition from hover to fixed-wing flight and at higher speeds when in conjunction with an intake cowl. Additionally, the slats' physical structure serves as a safety barrier, preventing large foreign objects from entering the duct and damaging the impeller. Advantageously, the combination of the lower lip 205, vanes and strakes, and the intake slats 206 (also called intake aerodynamic devices) is configured to turn the entire duct into a highly efficient circularized wing. While the slats control the air entering the top of the duct to ensure smooth flow, the lower lip, vanes, and strakes control the air exiting the bottom to maximize pressure. This synergy minimizes the download penalties typically associated with VTOL fuselages and allows for a smaller, lighter wing structure 203 because the ducts themselves are contributing a larger share of the total lift.

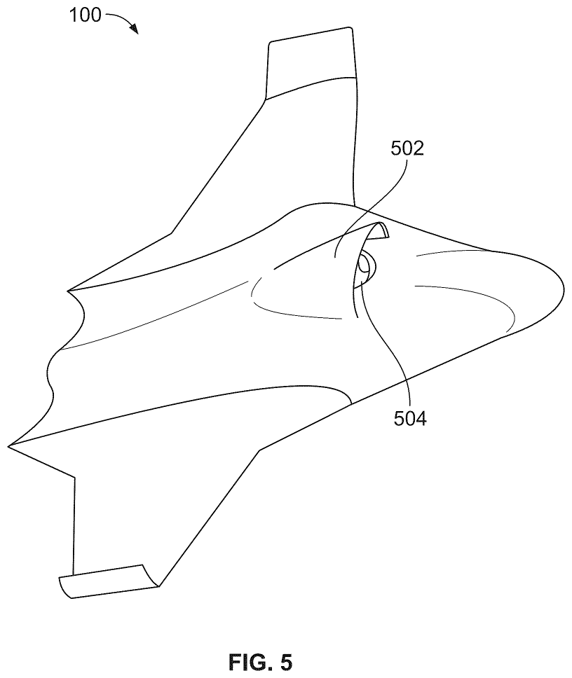

FIG. 5 depicts a side lateral perspective view of an air vehicle 100. The cowl 502 is shown deployed, and the ducted fan intake 504 is shown. In accordance with a specific embodiment, the movable intake cowl 502 includes a turbulent boundary layer internal dimpling. The turbulent boundary layer internal dimpling can refer to the intentional incorporation of concave dimpled surface features on the internal walls of an aerospace flow passage to manipulate the turbulent boundary layer, enhancing near-wall mixing, heat transfer, and/or flow stability while controlling pressure losses. The turbulent boundary layer can be defined as the region of fluid flow adjacent to a solid surface in which the flow is fully turbulent, characterized by chaotic, three-dimensional velocity fluctuations that dominate momentum, heat, and mass transfer between the surface and the external flow.

FIG. 6 depicts a top rear perspective view of the air vehicle 100 of FIG. 5. The cowl 502 is shown retracted, and the ducted fan intake 504 is shown.

FIG. 7 depicts a side view of the air vehicle 100 of FIG. 5. Thrust vector vanes 702 are depicted along with ducted fan intake 504.

### Cowl Actuator

Referring to FIG. 5 and FIG. 6, the actuator specifications for the movable intake cowl 502 and the thrust vector vanes 702 can be defined by the torque and response-time requirements established through aerodynamic modelling and wind-tunnel testing. These actuators can be configured to transition the cowl between the retracted hover position and the deployed forward-flight position, optimizing parameters of interest, such as boundary-layer attachment. The resultant aerodynamic specifications can be integrated into flight test simulations to ensure precise control over the air vehicle's attitude and transition phases, providing the flight control system (FCS) with the necessary data to modulate control surface deflection, preferably without incurring unnecessary aerodynamic drag. However, using the cowl as an airbrake during the deceleration transition is an option to reduce time spent sitting on thrust.

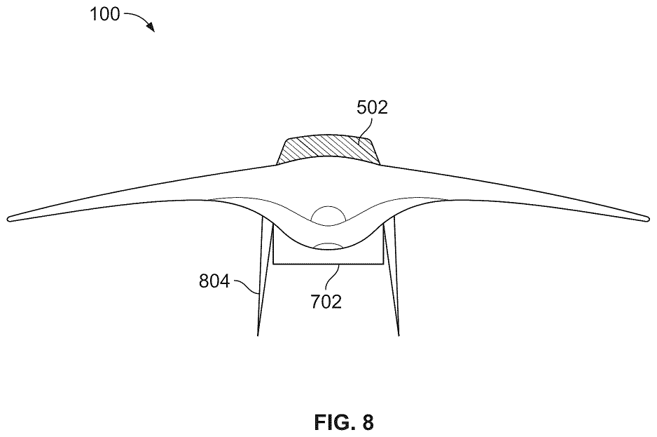

FIG. 8 depicts a front view of the air vehicle 100 of FIG. 5. Intake cowl 502 is shown, along with recirculating thrust bubble strakes 804 and thrust vector vanes 702.

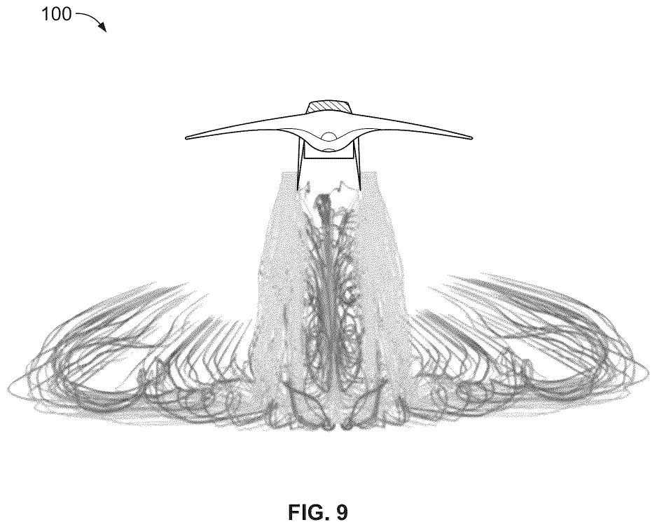

FIG. 9 depicts another front view of the air vehicle 100 of FIG. 5. This figure shows the expected airflow pattern from two sides of an air vehicle with ducted fan(s) exhausts.

### Flight Controls

Referring to FIG. 9, the air vehicle can utilize a fly-by-wire Flight Control System (FCS), which is known and not depicted, to manage stability and maneuverability through precise thrust vectoring control. The FCS processes high-fidelity data from a suite of onboard sensors, including Inertial Measurement Units (IMUs) for attitude sensing, GPS (Global Positioning System) for positional data, and barometric sensors for altitude and airspeed, to modulate (control) the deflection of the thrust vectoring vanes. For precision hovering and obstacle avoidance, the system may further incorporate LIDAR (Light Detection and Ranging) sensors to provide (near) real-time environmental mapping. These inputs allow the FCS to command (near) instantaneous adjustments to the thrust vector and motor rotational speed, to improve or ensure stable transition between vertical and horizontal flight modes.

By integrating the features described herein, the assembly depicted in FIG. 5 provides a compound benefit, and, when used with multiple ducts interacting as depicted in FIG. 2, can create a “bubble” of low pressure above the vehicle. This allows the vehicle to achieve mission success with lower fuel or energy burn than open-rotor designs. At the same time, the duct's inherent structural containment rings significantly improve safety compared to exposed blades.

### Additional Description

Referring to FIG. 5, traditional vertical lift systems, such as open-rotor quadcopters or helicopters, suffer from inherent inefficiencies. Helicopters, for example, can lose up to 15% of their thrust due to the fuselage impinging upon the rotor downwash. Furthermore, conventional VTOL designs often lack efficient transitions between hover and forward flight, requiring high throttle settings and complex mechanical gearboxes that increase maintenance costs and noise signatures. Vectoring the thrust aft with vanes provides forward impulsion for forward flight and powered flight control in three axes using differential deflections.

Referring to FIG. 5, an integrated ducted fan system is provided where the aerodynamic shaping of the inlet and exhaust interact to optimize lift. Aspects include: (A) compound lift generation by utilizing the upper surface of the vehicle as a low-pressure lifting body, (B) adaptive intake by using a movable cowl system that transitions between high mass flow (hover) and low drag (forward flight), (C) thrust containment by vertical strakes that capture a high-pressure bubble in ground effect to reduce fuel burn, (D) powered control by thrust vector vanes that provide maneuverability without the drag of conventional airframe control surfaces.

### Intake System and Upper Surface Aerodynamics

Referring to FIG. 1, the system employs a series of intake devices 101 (also called an aerodynamic slat/stator stage) that are designed to, or configured as, bifurcated inlets. In a hover, these slats allow for maximum mass flow. During forward flight, they function as wing slats to maintain boundary-layer attachment across the low-pressure-generating upper surface 202 of the vehicle (FIG. 2). A feature is the movable intake cowl. In the retracted position, the cowl allows for the unrestricted air volume required for heavy-lift hover evolutions. In the deployed position, the cowl moves forward to streamline the intake, reducing drag and improving intake dynamics at high speed. can be linearly or radially actuated. In the retracted position (as shown), it allows maximum unconstricted mass flow for heavy-lift hover operations. When deployed forward during high-speed fixed-wing flight, it reduces the overall intake aperture, significantly decreasing parasitic drag and bending the air more efficiently into the impeller's face to optimize intake dynamics.

### Mechanical Impeller System

Referring to FIG. 5, the vehicle can use hub-driven fans or rim-driven impellers embedded in the duct. This electrical configuration eliminates the weight of epicyclic gearboxes and provides instantaneous RPM rise times. To mitigate noise, the impeller blades are specifically spaced to avoid harmonics and shaped to spread acoustic frequencies across a broader spectrum.

### Exhaust Dynamics and Ground Effect

Referring to FIG. 1, the exhaust stage is optimized for both lift and control. A forward exhaust lip 105, also called an exhaust outlet front lip/vane, is positioned to increase the coefficient of lift CL during forward flight by up to 50%. Beneath the vehicle, vertical exhaust strakes 106 (also called strakes) are aligned with the direction of flight. When the vehicle is in ground effect (near the surface), these strakes contain a recirculating “thrust bubble” or rising column of high-pressure air. This allows the vehicle to maintain hover at a steady-state power setting, significantly reducing fuel consumption.

### Maneuverability and Thrust Vectoring

Referring to FIG. 8, control is achieved through thrust vector vanes located at the duct outlet. These vanes act as powered control surfaces for station-keeping and maneuvering. Unlike conventional ailerons or rudders, these vanes do not cause additional aerodynamic drag on the airframe during flight transitions, as they modulate the already accelerated exhaust air.

### Safety and Environmental Benefits

Referring to FIG. 1, the design incorporates a slat stage 101 and a stator stage 104 that serves as a protective barrier against Foreign Object Debris (FOD), along with the vanes 702 depicted in FIG. 7, and the duct 102 provides structural containment/attachment for the impeller. By utilizing sustainable power sources such as hydrogen fuel cells or SAF-powered microturbines, the system offers a reduced infrared (IR) signature and lower acoustic profile, making it suitable for both urban and military applications.

### Additional Description

Feature 1. An apparatus comprises: a vehicle; and an aerodynamically enhanced ducted fan system configured to be mounted to the vehicle, and also configured to urge movement of the vehicle.
Feature 2. A method of moving a vehicle including a ducted fan system, the method comprises: activating the ducted fan system with aerodynamic enhancements and shaping configured at the inlet and exhaust to urge movement of the vehicle.
Feature 3. A method of vehicle control, the method comprises: activating the ducted fan system configured to vary or deflect duct outlet air.
Feature 4. A method of vehicle noise signature management including a ducted fan system, the method comprises: activating the ducted fan system configured to spread frequencies and absorb noise.
Feature 5. A method of thrust deflection in hover flight, the method comprises: activating the ducted fan thrust deflection system configured to create lateral force to induce lateral movement, whereby the method provides a benefit in not reducing overall air vehicle lift.
Feature 6. A method of thrust deflection in transition and fixed-wing flight, the method comprises: activating the ducted fan thrust deflection system configured to create powered control forces to provide flight control in transition and fixed wing flight, whereby the method provides benefit in not causing additional aerodynamic drag from conventional airframe-mounted control surface deflection.
Feature7. A heavy-lift ducted fan vehicle system comprises: at least one ducted fan embedded within a vehicle structure, the ducted fan including a duct housing and an internal impeller; an aerodynamic intake comprising a plurality of bifurcated intake slats and a movable intake cowl, and said movable intake cowl configured to retract during a hover phase to maximize mass flow and to deploy forward during a fixed-wing flight phase to reduce intake area and drag; and an exhaust system comprising a plurality of vertical exhaust strakes and at least one forward exhaust lip and/or vane, wherein the strakes are configured to contain a high-pressure air region beneath the vehicle when in ground effect.
Feature 8. The system of Feature 7, wherein the movable intake cowl includes a turbulent boundary layer internal dimpling.
Feature 9. The system of Feature 7, further comprising: a stator stage positioned within the duct, the stator stage configured to provide at least one of a lifting vector, a safety barrier against foreign object debris, torque correction, or structural support for the fan in the duct.
Feature 10. The system of Feature 7, wherein the internal impeller is any one of a rim-driven electric fan and a hub-driven electric fan configured to provide instantaneous revolutions per minute (RPM) rise times and lower drive draw compared to open-rotor systems.
Feature 11. The system of Feature 7, wherein the exhaust system further comprises a plurality of thrust vector vanes configured to act as powered control surfaces in both hover and forward flight phases.
Feature 12. A method of inducing lift and providing control for a ducted fan vehicle, the method comprises: activating a ducted fan system embedded in a vehicle airframe; manipulating an intake cowl between a retracted hover position and a deployed forward-flight position to optimize airflow velocity and drag; capturing a recirculating thrust bubble between a plurality of exhaust strakes and/or vanes to provide ground-effect lift; and deflecting air at a duct outlet via a plurality of vanes to induce lateral movement without reducing overall vehicle lift.
Feature 13. The method of Feature 12, further comprising managing the vehicle's acoustic signature by utilizing impeller blades with varied spacing and shapes configured to spread noise frequencies across a broad spectrum.
Feature 14. The method of Feature 12, wherein the deflection of air at the duct outlet during fixed-wing flight provides flight control forces without the aerodynamic drag penalty associated with conventional external control surface deflection.
Feature 15. A method of increasing the efficiency of a VTOL vehicle, the method comprises: utilizing a duct cross-section shaped as a circularized wing profile to generate low pressure on the vehicle's upper surface; employing a forward exhaust lip on a leading edge of a duct outlet to increase the maximum coefficient of lift during forward flight; and maintaining a steady-state power setting during hover by utilizing vertical strakes to trap high-pressure air beneath the vehicle.

### Further Additional Description

Feature 1. An apparatus comprises: a vehicle; and an aerodynamically enhanced ducted fan system configured to be mounted to the vehicle and to urge movement of the vehicle.
Feature 2. The apparatus of Feature 1, wherein the ducted fan system includes a duct housing and an internal impeller.
Feature 3. The apparatus of Feature 2, wherein the ducted fan system includes an aerodynamic intake comprising a plurality of bifurcated intake slats and a movable intake cowl, the movable intake cowl configured to retract during a hover phase to maximize mass flow and to deploy forward during a fixed-wing flight phase to reduce intake area and drag.
Feature 4. The apparatus of Feature 3, wherein the movable intake cowl includes a turbulent boundary layer internal dimpling.
Feature 5. The apparatus of Feature 3, further comprising a stator stage positioned within the duct housing, the stator stage configured to provide at least one of a lifting vector, a safety barrier against foreign object debris, torque correction, or structural support for the internal impeller.
Feature 6. The apparatus of Feature 2, wherein the internal impeller is rim-driven or hub-driven and configured to provide instantaneous revolutions per minute (RPM) rise times and lower drive draw compared to open-rotor systems.
Feature 7. The apparatus of Feature 2, wherein the ducted fan system further comprises an exhaust system comprising a plurality of vertical exhaust strakes and at least one forward exhaust lip and/or vane.
Feature 8. The apparatus of Feature 7, wherein the exhaust system further comprises a plurality of thrust vector vanes configured to act as powered control surfaces in both hover and forward flight phases.
Feature 9. The apparatus of Feature 7, wherein the vertical exhaust strakes are configured to contain a high-pressure air region beneath the vehicle when in ground effect.
Feature 10. The apparatus of Feature 2, wherein a cross-section of the duct housing is shaped as a circularized wing profile to generate low pressure on an upper surface of the vehicle.
Feature 11. The apparatus of Feature 2, further comprising a flight control system configured to drive vanes placed in the exhaust as powered control surfaces.
Feature 12. A method of inducing lift and providing control for a ducted fan vehicle, the method comprising: activating a ducted fan system embedded in a vehicle airframe; manipulating an intake cowl between a retracted hover position and a deployed forward-flight position to optimize airflow velocity and drag; capturing a recirculating thrust bubble between a plurality of exhaust strakes to provide ground-effect lift; and deflecting air at a duct outlet via a plurality of vanes to induce lateral movement without reducing overall vehicle lift.
Feature 13. The method of Feature 12, further comprising managing the vehicle's acoustic signature by utilizing impeller blades with varied spacing and shapes configured to spread noise frequencies across a broad spectrum.
Feature 14. The method of Feature 12, wherein deflection of air at the duct outlet during fixed-wing flight provides flight control forces without the aerodynamic drag penalty associated with conventional external control surface deflection.
Feature 15. A heavy-lift ducted fan vehicle system comprises: at least one ducted fan embedded within a vehicle structure, the ducted fan including a duct housing and an internal impeller; an aerodynamic intake comprising a plurality of bifurcated intake slats and a movable intake cowl configured to retract during a hover phase to maximize mass flow and to deploy forward during a fixed-wing flight phase to reduce intake area and drag; and an exhaust system comprising a plurality of vertical exhaust strakes, control vanes, and at least one forward exhaust lip and/or vane, wherein the strakes are configured to contain a high-pressure air region beneath the vehicle when in ground effect.
Feature 16. The system of Feature 15, wherein the movable intake cowl is linearly or radially actuated into position.
Feature 17. The system of Feature 15, wherein the internal impeller is rim-driven.
Feature 18. The system of Feature 15, further comprising a stator stage positioned within the duct housing.
Feature 19. The system of Feature 15, further comprising a modular stub wing assembly positioned at lateral extremities of the airframe.
Feature 20. The system of Feature 15, wherein a top surface of the vehicle between and around duct intakes is an integrated low-pressure upper surface configured as a continuous aerodynamic lifting body.

Although the aspects of the invention have been described in connection with preferred embodiments, it should be understood that various modifications, additions and alterations may be made to the invention by one skilled in the art without departing from the spirit and scope of the invention as defined in the appended claims.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open-ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees. It may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the area, disposition, or configuration of the relevant element to preserve operability of the component within the disclosure, which does not materially modify the disclosure. Similarly, unless specifically made clear from its context, numerical values should be construed to include tolerances that a person skilled in the art would recognize as negligible, as they do not materially affect the operability of the disclosure. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments, even if not expressly stated as such above. It will be appreciated that persons skilled in the art would know that different configurations of the components of the apparatus may be possible to accommodate manufacturing requirements and remain within the scope as described in at least one or more of the claims. This written description provides embodiments, including the best mode, and enables the person skilled in the art to make and use them. The claims may define the patentable scope. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the disclosure. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a vehicle; and
an aerodynamically enhanced ducted fan system configured to be mounted to the vehicle and to urge movement of the vehicle.

2. The apparatus of claim 1, wherein the ducted fan system includes a duct housing and an internal impeller.

3. The apparatus of claim 2, wherein the ducted fan system includes an aerodynamic intake comprising a plurality of bifurcated intake slats and a movable intake cowl, the movable intake cowl configured to retract during a hover phase to maximize mass flow and to deploy forward during a fixed-wing flight phase to reduce intake area and drag.

4. The apparatus of claim 3, wherein the movable intake cowl includes a turbulent boundary layer internal dimpling.

5. The apparatus of claim 3, further comprising a stator stage positioned within the duct housing, the stator stage configured to provide at least one of a lifting vector, a safety barrier against foreign object debris, torque correction, or structural support for the internal impeller.

6. The apparatus of claim 2, wherein the internal impeller is rim-driven or hub-driven and configured to provide instantaneous revolutions per minute (RPM) rise times and lower drive draw compared to open-rotor systems.

7. The apparatus of claim 2, wherein the ducted fan system further comprises an exhaust system comprising a plurality of vertical exhaust strakes and at least one forward exhaust lip or vane.

8. The apparatus of claim 7, wherein the exhaust system further comprises a plurality of thrust vector vanes configured to act as powered control surfaces in both hover and forward flight phases.

9. The apparatus of claim 7, wherein the vertical exhaust strakes are configured to contain a high-pressure air region beneath the vehicle when in ground effect.

10. The apparatus of claim 2, wherein a cross-section of the duct housing is shaped as a circularized wing profile to generate low pressure on an upper surface of the vehicle.

11. The apparatus of claim 2, further comprising a flight control system configured to drive vanes placed in the exhaust as powered control surfaces.

12. A method of inducing lift and providing control for a ducted fan vehicle, the method comprising:
activating a ducted fan system embedded in a vehicle airframe; manipulating an intake cowl between a retracted hover position and a deployed forward-flight position to optimize airflow velocity and drag;
capturing a recirculating thrust bubble between a plurality of exhaust strakes to provide ground-effect lift; and
deflecting air at a duct outlet via a plurality of vanes to induce lateral movement without reducing overall vehicle lift.

13. The method of claim 12, further comprising managing the vehicle's acoustic signature by utilizing impeller blades with varied spacing and shapes configured to spread noise frequencies across a broad spectrum.

14. The method of claim 12, wherein deflection of air at the duct outlet during fixed-wing flight provides flight control forces without the aerodynamic drag penalty associated with conventional external control surface deflection.

15. A heavy-lift ducted fan vehicle system, comprising:
at least one ducted fan embedded within a vehicle structure, the ducted fan including a duct housing and an internal impeller;
an aerodynamic intake comprising one or more bifurcated intake slats and one or more movable intake cowls configured to retract during a hover phase; and
an exhaust system comprising one or more vertical exhaust strakes, and at least one forward exhaust vane, wherein the strakes are configured to contain a high-pressure air region beneath the vehicle when in ground effect.

16. The system of claim 15, wherein the movable intake cowl is linearly or radially actuated into position.

17. The system of claim 15, wherein the internal impeller is rim-driven.

18. The system of claim 15, further comprising a stator stage positioned within the duct housing.

19. The system of claim 15, further comprising a modular stub wing assembly positioned at lateral extremities of the airframe.

20. The system of claim 15, wherein a top surface of the vehicle between and around duct intakes is an integrated low-pressure upper surface configured as a continuous aerodynamic lifting body, and wherein the one or more bifurcated intake slats and the one or more movable intake cowls are configured to maximize mass flow and to deploy forward during a fixed-wing flight phase to reduce intake area and drag.
